(19) United States
(12) Patent Application Publication
(10) Pub. No.: US 2022/0390176 A1
(43) Pub. Date: Dec. 8, 2022

(54) OVEN MADE OF REFRACTORY MATERIAL

(71) Applicant: Hector Pascual De Las Heras, Zamora (ES)

(72) Inventor: Hector Pascual De Las Heras, Zamora (ES)

(21) Appl. No.: 17/776,036

(22) PCT Filed: Nov. 11, 2020
(86) PCT No.: PCT/ES2020/070701

§ 371 Date: May 11, 2022

(30) Foreign Application Priority Data
Nov. 12, 2019 (ES) U201931865

(51) Int. Cl. F27D 1/10; F27D 1/00

(52) U.S. Cl. CPC F27D 1/10; F27D 1/0006

(57) ABSTRACT

Oven (1), of the type comprising a receptacle (2) of refractory material, which comprises two concave pieces (3, 4) that are joined by the edges (5) thereof with the participation of a refractory binder (6), the pieces (3, 4) comprising a recess (7) in the edge thereof to form the entrance to the oven, and mutually coupling tongue-and-groove joints (50).

### OBJECT OF THE INVENTION

The present invention relates to an oven made of refractory material, suitable for working as a woodfired oven.

### BACKGROUND OF THE INVENTION

Several types of ovens are currently known, some are made of refractory material, which are handcrafted using refractory bricks joined together by a refractory mortar paste. There is also another type of oven that is manufactured manually with a mass of clay and kaolin, whereby a single-piece hemisphere-shaped oven is built.

These ovens are heated with a wood or gas heat source, whereby the structure of the oven is charged with heat, which is slowly returned to the interior, creating an enveloping heat around the food. The configuration of this type of oven requires manual and artisanal manufacturing, which means that the price of the product is extremely high given its low productivity.

With the invention that we provide, we obtain a higher quality oven with a configuration that can be manufactured with a much higher productivity.

### DESCRIPTION OF THE INVENTION

The oven of the invention is of the type that comprises a receptacle of refractory material, wherein according to the invention, the receptacle comprises two concave pieces in the form of hollow hemispheres, and therefore lacks negatives that hinder its demolding, achieving quick and easy manufacturing using simple molds.

In this way we get to manufacture an oven by simply joining 2 pieces with an adequate thickness to obtain an ideal temperature load for cooking.

This configuration also allows the manufacture with molds with high pressure application, obtaining a much higher productivity with a low manufacturing cost, and a greater compaction of the refractory clay mass, achieving the removal of the air particles, whereby we gain a higher temperature load on its walls.

### BRIEF DESCRIPTION OF THE DRAWINGS

FIG. 1 shows a view of the two pieces that shall form the oven of the invention, recently unmolded and in the upper open position, so that the concavity thereof can be appreciated.

FIG. 2 shows a view similar to FIG. 1, wherein the upper part has been turned over prior to being placed on the lower part.

FIG. 3 shows a view of the finished oven, and a detail of the contact area between the two pieces, which are joined by refractory cement.

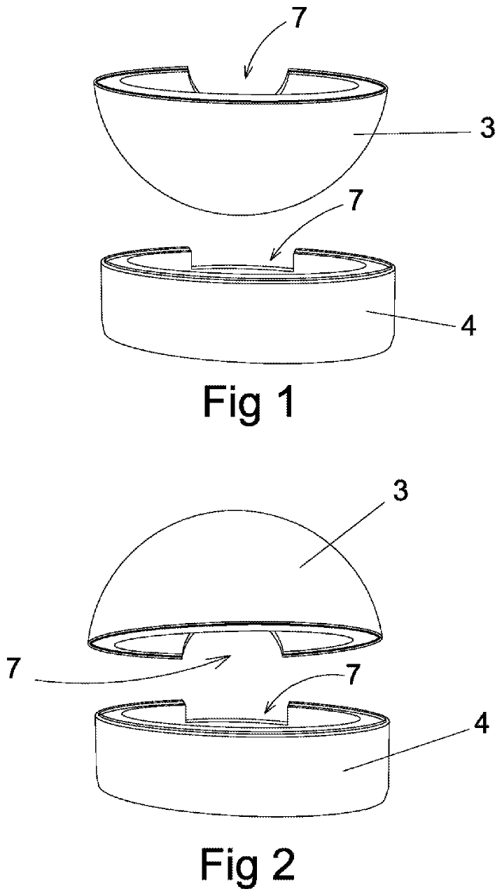

### DESCRIPTION OF A PRACTICAL EMBODIMENT OF THE INVENTION

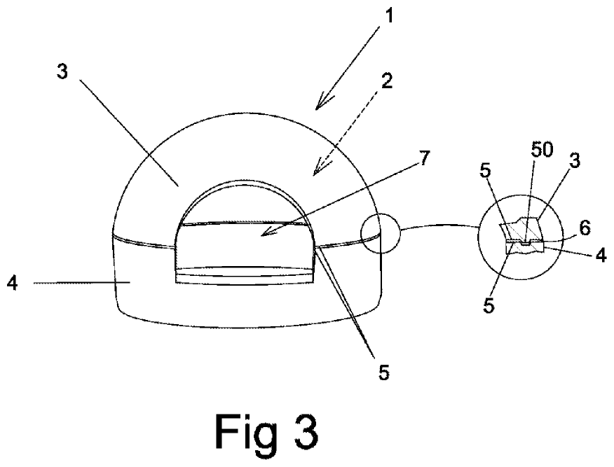

The oven (1) of the invention (see FIG. 3) is of the type that comprises a receptacle (2) of refractory material, wherein the receptacle (2) comprises two concave pieces (3, 4) that are joined by the edges (5) thereof.

Very preferably the edges (5) are joined with the participation of a refractory binder (6), since on the one hand it reinforces the joint, and on the other hand it cooperates in sealing the receptacle (2) against heat leaks. Said binder (6) ideally comprises refractory mortar.

In addition, it has been provided that the edges (5) are preferably coplanar in each piece (3, 4), that is, that all their points are contained in the same plane with the logical tolerances. In this case, entrance to the oven can be achieved by means of a recess (7) in the edge of the pieces (3, 4). It has also been provided that the edges (5) of both pieces may comprise mutually coupling tongue-and-groove joints (50), also to reinforce the settlement between both pieces (3, 4) and to prevent heat leaks.

Having sufficiently described the nature of the present invention, as well as a way of putting it into practice, it should be noted that the provisions indicated above and represented in the attached drawings are susceptible to modifications in detail as long as they do not alter the fundamental principle

1. Oven (1), of the type comprising a receptacle (2) of refractory material, characterized in that the receptacle (2) comprises two concave pieces (3, 4) that are joined by the edges (5) thereof.

2. Oven (1) according to claim 1, wherein the edges (5) are joined with the participation of a refractory binder (6).

3. Oven (1) according to claim 2, wherein the binder (6) comprises refractory mortar.

4. Oven (1) according to any of the preceding claims, wherein the edges (5) are coplanar in each piece (3, 4), the pieces (3, 4) comprising a recess (7) in the edge thereof to form the entrance to the oven.

5. Oven (1) according to any of the preceding claims, wherein the edges (5) of both pieces comprise mutually coupling tongue-and-groove joints (50).
